(19) United States
(12) Patent Application Publication
(10) Pub. No.: US 2026/0135113 A1
(43) Pub. Date: May 14, 2026

(54) ELECTRODE MEMBER

(71) Applicant: TOYOTA JIDOSHA KABUSHIKI KAISHA, Toyota-shi (JP)

(72) Inventors: Mitsuru TATEISHI, Toyota-shi (JP); Masashi UEDA, Toyota-shi (JP); Jun IZUMI, Toyota-shi (JP); Shizuka MASUOKA, Nagoya-shi (JP); Aya SATO, Nagoya-shi (JP); Keitaro MACHIDA, Hamamatsu-shi (JP); Yuji KATAYAMA, Okazaki-shi (JP); Tatsuya YAMAMOTO, Toyohashi-shi (JP)

(73) Assignee: TOYOTA JIDOSHA KABUSHIKI KAISHA, Toyota-shi (JP)

(21) Appl. No.: 19/362,664

(22) Filed: Oct. 20, 2025

(30) Foreign Application Priority Data
Nov. 8, 2024 (JP) 2024-195640

(51) Int. Cl. H01M 4/62; H01M 10/0587

(52) U.S. Cl. CPC H01M 4/628; H01M 10/0587

(57) ABSTRACT

A first current collector (electrode member) includes an insulating substrate and a first conductive layer provided on a surface of the insulating substrate. A plurality of fillers that reduces the difference between the linear expansion coefficient of the insulating substrate and the linear expansion coefficient of the first conductive layer is dispersed inside the insulating substrate. The difference between the linear expansion coefficient of the insulating substrate in which the fillers are dispersed and the linear expansion coefficient of the first conductive layer is within ±20% of the linear expansion coefficient of the first conductive layer.

### CROSS-REFERENCE TO RELATED APPLICATION

This application claims priority to Japanese Patent Application No. 2024-195640 filed on Nov. 8, 2024. The disclosure of the above-identified application, including the specification, drawings, and claims, is incorporated by reference herein in its entirety.

### BACKGROUND

### 1. Technical Field

The present disclosure relates to an electrode member.

### 2. Description of Related Art

Japanese Unexamined Patent Application Publication No. 2019-96592 (JP 2019-96592 A) discloses an electrode member including an insulating substrate and a conductive layer provided on a surface of the insulating substrate.

### SUMMARY

When the temperature of such an electrode member changes, the conductive layer is likely to peel off from the insulating substrate.

An object of the present disclosure is to suppress peeling of a conductive layer in an electrode member.

An aspect of the present disclosure provides an electrode member including: an insulating substrate; and a conductive layer provided on a surface of the insulating substrate. A plurality of fillers that reduces a difference between a linear expansion coefficient of the insulating substrate and a linear expansion coefficient of the conductive layer is dispersed inside the insulating substrate. The difference between the linear expansion coefficient of the insulating substrate in which the fillers are dispersed and the linear expansion coefficient of the conductive layer is within ±20% of the linear expansion coefficient of the conductive layer.

Preferably, the fillers are glass fibers.

Preferably, the insulating substrate includes a body portion on which an active material layer is stacked, and a protruding piece portion that is connected to the body portion and protrudes outward from the body portion. The fillers may have an elongated shape. In the protruding piece portion, a longitudinal direction of the fillers may be parallel to a protruding direction of the protruding piece portion.

Preferably, the insulating substrate includes a body portion on which an active material layer is stacked, and a protruding piece portion that is connected to the body portion and protrudes outward from the body portion. The fillers may have an elongated shape. In the protruding piece portion, a longitudinal direction of the fillers may intersect a protruding direction of the protruding piece portion.

Preferably, the insulating substrate includes a body portion on which an active material layer is stacked, and a protruding piece portion that is connected to the body portion and protrudes outward from the body portion. The fillers may have an elongated shape. In a wound body obtained by winding the insulating substrate, a longitudinal direction of the fillers provided in the body portion may be along a winding direction of the insulating substrate.

According to the present disclosure, it is possible to suppress peeling of a conductive layer in an electrode member.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view illustrating a battery including an electrode member according to the present embodiment;

FIG. 2 is a cross-sectional view of an electrode body 10 illustrated in FIG. 1, taken along the line II-II and viewed in the direction of the arrows;

FIG. 3 is a cross-sectional view of the electrode body 10 illustrated in FIG. 1, taken along the line III-III and viewed in the direction of the arrows;

FIG. 4 is an enlarged partial cross-sectional view of a region IV of a first electrode in FIG. 3;

FIG. 5 is a development view of an insulating substrate 110 illustrated in FIG. 4; and

FIG. 6 is a development view of an insulating substrate according to a modification.

### DETAILED DESCRIPTION OF EMBODIMENTS

An embodiment and a modification of the present disclosure will be described in detail below with reference to the drawings. The same reference symbols are given to the same or equivalent portions in the drawings, and the description of such portions will not be repeated.

### Embodiment

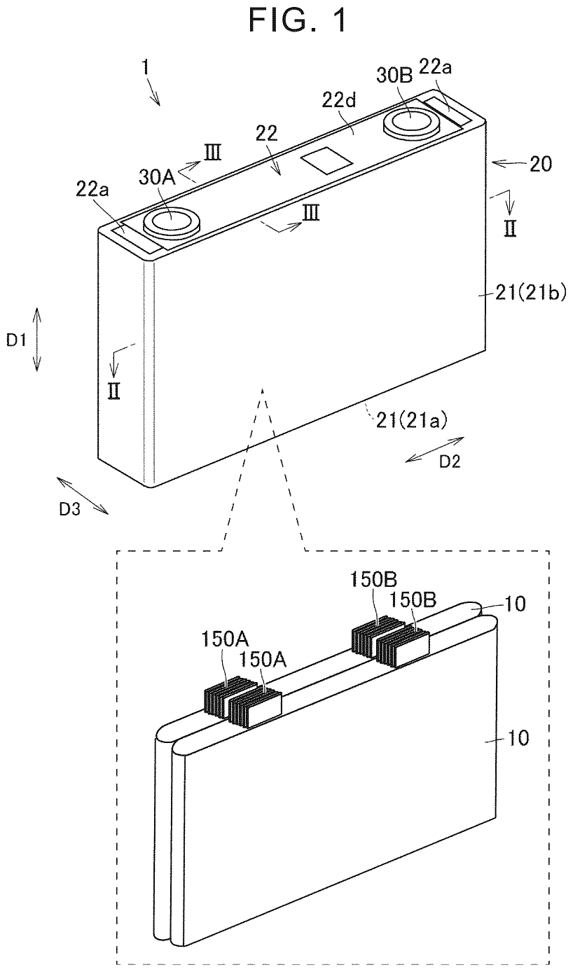

FIG. 1 is a perspective view illustrating a battery including an electrode member according to the present embodiment. As illustrated in FIG. 1, a battery 1 including an electrode member according to the present embodiment is a so-called rectangular battery. The battery 1 may be a secondary battery configured to be charged and discharged such as a lithium-ion battery or a nickel metal hydride battery. The battery 1 can be used, for example, as a cell included in a power storage module mounted on an electrified vehicle.

The battery 1 includes an electrode body 10, a case 20, a first external terminal 30A, a second external terminal 30B, a first coupling member (not illustrated), a second coupling member (not illustrated), and an insulating member (not illustrated). First, the configuration of the battery 1 other than the electrode body 10 will be described.

The case 20 is electrically conductive. An electrically conductive portion of the case 20 is made of a metal such as aluminum, for example. The case 20 houses the electrode body 10. The case 20 also houses an electrolytic solution (not illustrated).

The case 20 includes a case body 21 and a lid 22. The case body 21 includes a bottom wall 21a and a peripheral wall 21b that stands upright from the bottom wall 21a.

The bottom wall 21a is provided with a pressure relief valve (not illustrated). The bottom wall 21a and the pressure relief valve are made of a metal such as aluminum.

An opening is formed at the upper end of the peripheral wall 21b. The peripheral wall 21b has a substantially rectangular outer shape when viewed from the opening direction of the opening. The opening and the bottom wall 21a are arranged in a first direction D1. The first direction D1 may be the height direction or the up-down direction of the battery 1. In the present embodiment, the direction from the bottom wall 21a toward the lid 22 is referred to as “upward”, and the direction from the lid 22 toward the bottom wall 21a is referred to as “downward”. The peripheral wall 21b is made of a metal such as aluminum.

The lid 22 includes a lid body 22a and an insulating cover 22d. The lid body 22a is joined to the peripheral wall 21b by welding, etc., so as to close the opening of the peripheral wall 21b. The lid body 22a is formed with a liquid injection hole (not illustrated). The liquid injection hole is a through hole for injecting an electrolytic solution into the case body 21 in a process of manufacturing the battery 1. The liquid injection hole is sealed with a sealing plug. The insulating cover 22d covers the liquid injection hole and the sealing plug.

The lid 22 is provided with the first external terminal 30A and the second external terminal 30B. The first external terminal 30A and the second external terminal 30B are provided in the battery 1 so as to be exposed to the outside.

The first external terminal 30A is electrically connected to the electrode body 10 through the first coupling member. More specifically, the first external terminal 30A and the first coupling member are joined to each other. The first coupling member is joined to a plurality of tabs 150A of the electrode body 10.

The second external terminal 30B is electrically connected to the electrode body 10 through the second coupling member. More specifically, the second external terminal 30B and the second coupling member are joined to each other. The second coupling member is joined to a plurality of tabs 150B of the electrode body 10.

In the present embodiment, the first external terminal 30A is a positive electrode terminal, and the second external terminal 30B is a negative electrode terminal. The first external terminal 30A and the second external terminal 30B are arranged in a second direction D2. The second direction D2 is a direction orthogonal to the first direction D1.

The insulating member has electrical insulation properties. The insulating member is disposed between the electrode body 10 and the case 20. The insulating member electrically insulates the electrode body 10 and the case 20 from each other.

As illustrated in FIG. 1, the battery 1 according to the present embodiment includes a plurality of electrode bodies 10. The battery 1 typically includes two electrode bodies 10. These electrode bodies 10 are arranged in a third direction D3. The third direction D3 is a direction orthogonal to both the first direction D1 and the second direction D2.

In the following, one of the electrode bodies 10 will be described. Each of the electrode bodies 10 may have the configuration described below.

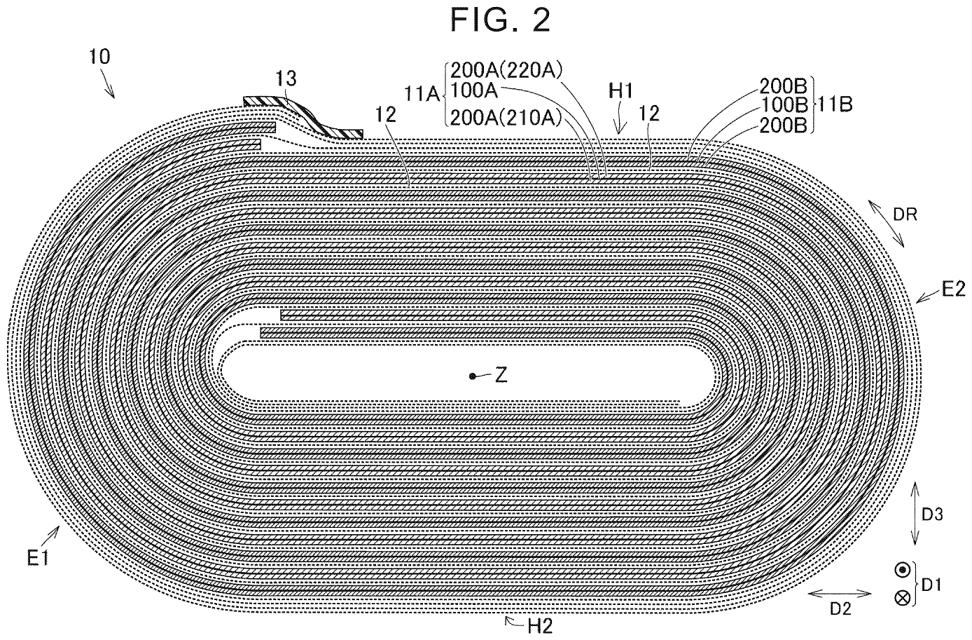

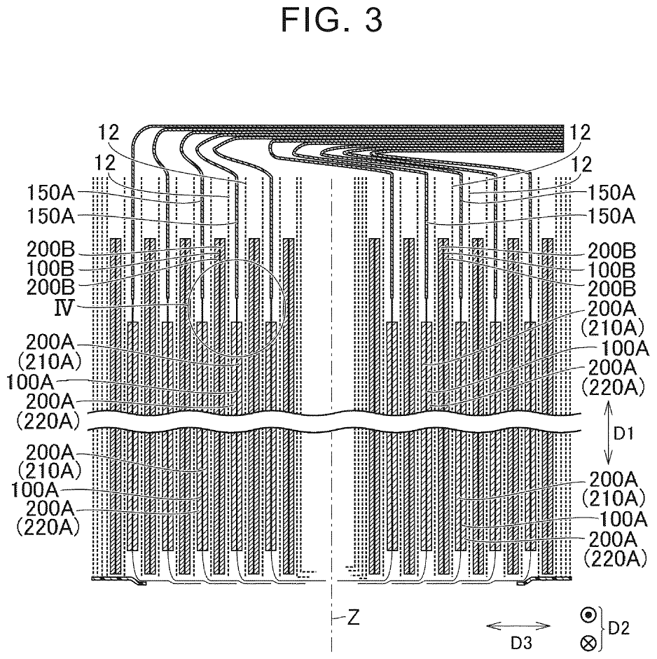

FIG. 2 is a cross-sectional view of the electrode body 10 illustrated in FIG. 1, taken along the line II-II and viewed in the direction of the arrows. FIG. 3 is a cross-sectional view of the electrode body 10 illustrated in FIG. 1, taken along the line III-III and viewed in the direction of the arrows. With reference to FIGS. 2 and 3, the electrode body 10 includes a first electrode 11A, a second electrode 11B, a separator 12, and a tape member 13. In the electrode body 10, the first electrode 11A, the second electrode 11B, and the separator 12 are wound so as to surround a winding axis Z. Thus, in the present embodiment, the electrode body 10 is a so-called wound electrode body. However, the electrode body 10 may be a stacked electrode body in which the first electrode 11A, the second electrode 11B, and the separator 12 are stacked in one direction (e.g., the third direction D3). In FIGS. 2 and 3, the separator 12 is schematically illustrated by dashed lines.

The first electrode 11A and the second electrode 11B have a sheet-like outer shape. The electrode body 10 includes an electrode plate group in which the first electrode 11A and the second electrode 11B are wound with one or more separators 12 sandwiched between the first electrode 11A and the second electrode 11B.

In the present embodiment, the first electrode 11A is a positive electrode, and the second electrode 11B is a negative electrode. However, the first electrode 11A may be a negative electrode, and the second electrode 11B may be a positive electrode.

The first electrode 11A includes a first current collector 100A and a first active material layer 200A. The first current collector 100A is an example of an “electrode member” according to the present disclosure. The first active material layer 200A is an example of an “active material layer” according to the present disclosure. The first active material layer 200A includes an inner active material layer 210A and an outer active material layer 220A. The second electrode 11B includes a second current collector 100B and a second active material layer 200B. The first active material layer 200A is a positive electrode active material layer, and the second active material layer 200B is a negative electrode active material layer. However, the first active material layer 200A may be a negative electrode active material layer, and the second active material layer 200B may be a positive electrode active material layer.

The separator 12 is provided between the first electrode 11A and the second electrode 11B. The separator 12 is stacked on the first active material layer 200A in a radial direction about the winding axis Z. The separator 12 is stacked on the inner active material layer 210A in the radial direction. The separator 12 is also stacked on the outer active material layer 220A in the radial direction.

The second electrode 11B is stacked on the first active material layer 200A with the separator 12 sandwiched between the second electrode 11B and the first active material layer 200A in the radial direction. More specifically, the second electrode 11B is stacked on the inner active material layer 210A with the separator 12 sandwiched between the second electrode 11B and the inner active material layer 210A, and is also stacked on the outer active material layer 220A with the separator 12 sandwiched between the second electrode 11B and the outer active material layer 220A.

The separator 12 separates the first electrode 11A from the second electrode 11B while allowing ions to travel between the first electrode 11A and the second electrode 11B. The ions are, for example, lithium ions. The separator 12 has electrical insulation properties.

Of the first electrode 11A, the second electrode 11B, and the separator 12, the separator 12 is located on the innermost peripheral side about the winding axis Z. In addition, of the first electrode 11A, the second electrode 11B, and the separator 12, the separator 12 is located on the outermost peripheral side about the winding axis Z. The outer peripheral edge of the separator 12 in a winding direction DR is fixed by the tape member 13 disposed on the outer peripheral surface of the separator 12.

The separator 12 may contain, for example, a polyolefin resin or the like. The separator 12 may be made substantially of a polyolefin resin, for example. The polyolefin resin may include, for example, at least one selected from the group consisting of polyethylene (PE) and polypropylene (PP).

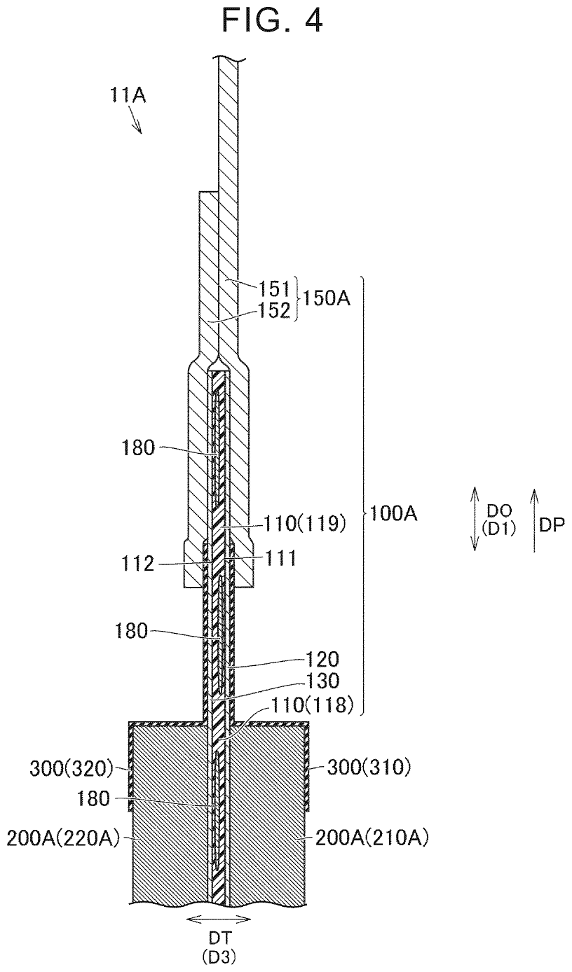

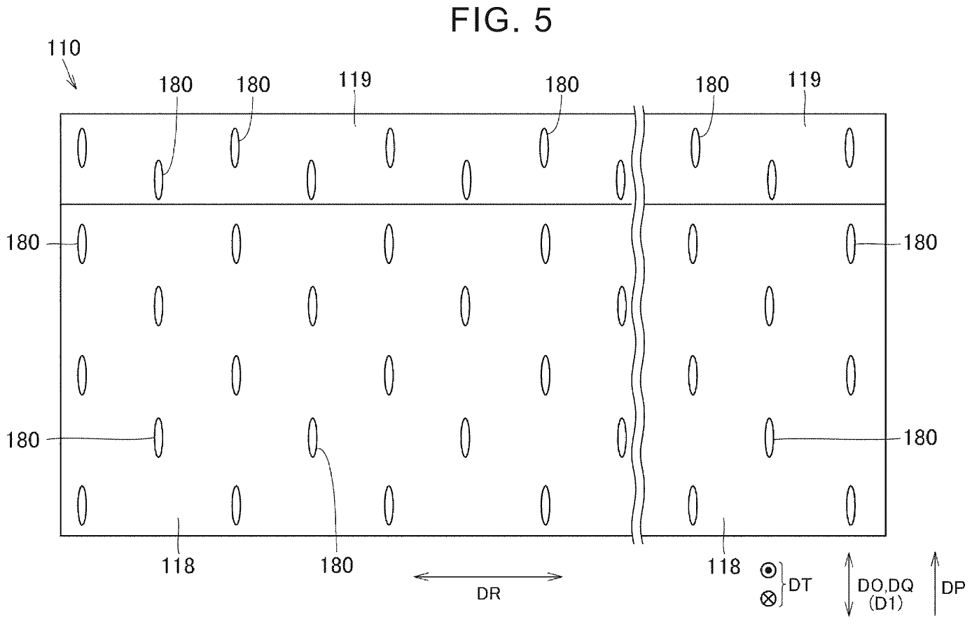

The detailed configuration of the first electrode 11A will be described with reference to FIGS. 4 and 5. FIG. 4 is an enlarged partial cross-sectional view of a region IV of the first electrode in FIG. 3. The first electrode 11A includes the first current collector 100A, the first active material layer 200A, and a protective portion 300.

The first current collector 100A includes an insulating substrate 110, a first conductive layer 120, a second conductive layer 130, and a tab 150A. Each of the first conductive layer 120 and the second conductive layer 130 is an example of a “conductive layer” according to the present disclosure.

The insulating substrate 110 is made of a resin composition having electrical insulation properties. Therefore, the first current collector 100A is a composite current collector made up of a conductive member and an electrically insulating member. Moreover, the insulating substrate 110 is made of a material having higher rigidity than the separator 12 (see FIG. 2). The insulating substrate 110 is made of a resin composition containing, for example, a polyamide resin, a polyester resin (e.g., polyethylene terephthalate), a polyolefin resin (e.g., polypropylene), polyethylene, PEEK, polycarbonate, or ABS. This makes it possible to increase the rigidity of the first current collector 100A while maintaining the electrical insulation properties of the insulating substrate 110. Furthermore, the insulating substrate 110 can be made relatively thin.

A thickness direction DT of the insulating substrate 110 is substantially parallel to the third direction D3. An orthogonal direction DO orthogonal to the thickness direction DT of the insulating substrate 110 is substantially parallel to the first direction D1. The insulating substrate 110 extends substantially parallel to the first direction D1. The insulating substrate 110 includes a first surface 111 and a second surface 112 disposed at a distance in the thickness direction DT. The first surface 111 is provided with a first conductive layer 120, and the second surface 112 is provided with a second conductive layer 130.

In order to reduce the overall thickness of the electrode body 10, the thickness of the insulating substrate 110 is preferably, for example, 20 μm or less, more preferably 15 μm or less, and even more preferably 10 μm or less. The thickness of the insulating substrate 110 is not particularly limited as long as the insulating substrate 110 has the desired rigidity. The thickness of the insulating substrate 110 may be, for example, 2 μm or more.

The insulating substrate 110 includes a body portion 118 on which the first active material layer 200A is stacked, and a protruding piece portion 119 that is connected to the body portion 118 and protrudes outward from the body portion 118. A protruding direction DP of the protruding piece portion 119 is along the orthogonal direction DO. The protruding piece portion 119 protrudes upward from the upper side of the body portion 118 along the orthogonal direction DO. That is, the protruding piece portion 119 protrudes upward from the upper side of the body portion 118 along the first direction D1.

Referring now to FIG. 5, the insulating substrate 110 will be described in further detail. FIG. 5 is a development view of the insulating substrate 110 illustrated in FIG. 4. FIG. 5 illustrates the insulating substrate 110 in a state before being wound. The insulating substrate 110 has a sheet-like outer shape.

A plurality of fillers 180 that reduces the difference in linear expansion coefficient between the insulating substrate 110 and the first conductive layer 120 (see FIG. 4) is dispersed inside the insulating substrate 110. The difference between the linear expansion coefficient of the insulating substrate 110 in which the fillers 180 are dispersed and the linear expansion coefficient of the first conductive layer 120 is within ±20% of the linear expansion coefficient of the first conductive layer 120. When the difference between the linear expansion coefficient of the insulating substrate 110 in which the fillers 180 are dispersed and the linear expansion coefficient of the first conductive layer 120 is within ±20% of the linear expansion coefficient of the first conductive layer 120, peeling of the first conductive layer 120 in the first current collector 100A (see FIG. 4) is suppressed.

The difference between the linear expansion coefficient of the insulating substrate 110 in which the fillers 180 are dispersed and the linear expansion coefficient of the first conductive layer 120 is preferably within ±10% of the linear expansion coefficient of the first conductive layer 120. The central portion of the electrode body 10 (see FIG. 1) in the first direction D1 is more likely to become hotter than the end portions of the electrode body 10 in the first direction D1. When the difference between the linear expansion coefficient of the insulating substrate 110 in which the fillers 180 are dispersed and the linear expansion coefficient of the first conductive layer 120 is within ±10% of the linear expansion coefficient of the first conductive layer 120, peeling of the first conductive layer 120 is suppressed in the central portion (i.e., the high temperature portion) of the electrode body 10 in the first direction D1.

The difference between the linear expansion coefficient of the insulating substrate 110 in which the fillers 180 are dispersed and the linear expansion coefficient of the first conductive layer 120 is more preferably within ±5% of the linear expansion coefficient of the first conductive layer 120. When the electrode body 10 (see FIG. 2) is viewed from above the electrode body 10, the electrode body 10 has arc portions E1, E2 (see FIG. 2) disposed at a distance in the second direction D2, and flat portions H1, H2 (see FIG. 2) disposed at a distance in the third direction D3. When the difference between the linear expansion coefficient of the insulating substrate 110 in which the fillers 180 are dispersed and the linear expansion coefficient of the first conductive layer 120 is within ±5% of the linear expansion coefficient of the first conductive layer 120, peeling of the first conductive layer 120 is suppressed in the arc portions E1, E2.

The fillers 180 reduce the difference between the linear expansion coefficient of the insulating substrate 110 and the linear expansion coefficient of the second conductive layer 130 (see FIG. 4). The difference between the linear expansion coefficient of the insulating substrate 110 in which the fillers 180 are dispersed and the linear expansion coefficient of the second conductive layer 130 is within ±20% of the linear expansion coefficient of the second conductive layer 130. When the difference between the linear expansion coefficient of the insulating substrate 110 in which the fillers 180 are dispersed and the linear expansion coefficient of the second conductive layer 130 is within ±20% of the linear expansion coefficient of the second conductive layer 130, peeling of the second conductive layer 130 in the first current collector 100A (see FIG. 4) is suppressed.

The difference between the linear expansion coefficient of the insulating substrate 110 in which the fillers 180 are dispersed and the linear expansion coefficient of the second conductive layer 130 is preferably within ±10% of the linear expansion coefficient of the second conductive layer 130. When the difference between the linear expansion coefficient of the insulating substrate 110 in which the fillers 180 are dispersed and the linear expansion coefficient of the second conductive layer 130 is within ±10% of the linear expansion coefficient of the second conductive layer 130, peeling of the second conductive layer 130 is suppressed in the central portion (i.e., the high temperature portion) of the electrode body 10 (see FIG. 1) in the first direction D1.

The difference between the linear expansion coefficient of the insulating substrate 110 in which the fillers 180 are dispersed and the linear expansion coefficient of the second conductive layer 130 is more preferably within ±5% of the linear expansion coefficient of the second conductive layer 130. When the difference between the linear expansion coefficient of the insulating substrate 110 in which the fillers 180 are dispersed and the linear expansion coefficient of the second conductive layer 130 is within ±5% of the linear expansion coefficient of the second conductive layer 130, peeling of the second conductive layer 130 is suppressed in the arc portions E1, E2 (see FIG. 2).

In the present embodiment, the fillers 180 reduce the difference between the linear expansion coefficient of the insulating substrate 110 and the linear expansion coefficient of each of the first conductive layer 120 and the second conductive layer 130. However, it is only necessary that the fillers 180 should reduce the difference between the linear expansion coefficient of the insulating substrate 110 and the linear expansion coefficient of at least one of the first conductive layer 120 and the second conductive layer 130.

The fillers 180 are, for example, glass fibers. When the fillers 180 are glass fibers, the linear expansion coefficient of the insulating substrate 110 can be more appropriately controlled.

The fillers 180 may be electrically conductive. When the insulating substrate 110 is made of a resin composition containing polyethylene terephthalate, the fillers 180 may be made of, for example, aluminum. When the fillers 180 are electrically conductive, the electrical resistance of the first current collector 100A (see FIG. 4) can be reduced.

The fillers 180 have an elongated shape. In the protruding piece portion 119, a longitudinal direction DQ of the fillers 180 is parallel to the protruding direction DP of the protruding piece portion 119. That is, the longitudinal direction DQ of the fillers 180 is parallel to the orthogonal direction DO. Further, the longitudinal direction DQ of the fillers 180 is substantially parallel to the first direction D1. Since the longitudinal direction DQ of the fillers 180 is parallel to the protruding direction DP of the protruding piece portion 119, it is possible to suppress the protruding piece portion 119 tearing in a direction (e.g., the winding direction DR of the insulating substrate 110) intersecting the protruding direction DP.

Also in the body portion 118, the longitudinal direction DQ of the fillers 180 is parallel to the protruding direction DP of the protruding piece portion 119. In a wound body obtained by winding the insulating substrate 110, the longitudinal direction DQ of the fillers 180 provided in the body portion 118 may be along the winding direction DR of the insulating substrate 110. In general, a resin composition is likely to shrink due to heat. However, when the longitudinal direction DQ of the fillers 180 provided in the body portion 118 is along the winding direction DR of the insulating substrate 110, the insulating substrate 110 is less likely to shrink with respect to each of the first conductive layer 120 and the second conductive layer 130 (see FIG. 4).

Referring again to FIG. 4, the first conductive layer 120 is stacked on the first surface 111 of the insulating substrate 110. The first conductive layer 120 is in contact with the insulating substrate 110 on one side in the thickness direction DT. In the present embodiment, the first conductive layer 120 is located on the winding axis Z side (see FIG. 3) when viewed from the insulating substrate 110. The first conductive layer 120 is in contact with the insulating substrate 110 over the entire surface on one side in the thickness direction DT.

The second conductive layer 130 is stacked on the second surface 112 of the insulating substrate 110. The second conductive layer 130 is in contact with the insulating substrate 110 on the other side in the thickness direction DT. In the present embodiment, the second conductive layer 130 is located on the opposite side of the winding axis Z (see FIG. 3) side when viewed from the insulating substrate 110. The second conductive layer 130 is in contact with the insulating substrate 110 over the entire surface on the other side in the thickness direction DT.

The first conductive layer 120 and the second conductive layer 130 are each made of a metal. In the present embodiment, the first conductive layer 120 and the second conductive layer 130 are made of a metal containing aluminum. This allows the first current collector 100A to be suitably used as a positive electrode current collector. The first current collector 100A may be a negative electrode current collector, and the first conductive layer 120 and the second conductive layer 130 may be made of a metal containing copper.

The thickness of each of the first conductive layer 120 and the second conductive layer 130 is less than the thickness of the insulating substrate 110. The thickness of each of the first conductive layer 120 and the second conductive layer 130 is, for example, 5 μm or less, more preferably 2μm or less, and even more preferably 1 μm or less, in order to reduce the overall thickness of the electrode body 10 (see FIG. 2). The thickness of each of the first conductive layer 120 and the second conductive layer 130 may be, for example, 0.1 μm or more, in order to suppress the electrical resistance of each of the first conductive layer 120 and the second conductive layer 130 becoming too large.

The first conductive layer 120 and the second conductive layer 130 are provided, for example, by evaporating a metal containing aluminum onto the insulating substrate 110. The first conductive layer 120 and the second conductive layer 130 may each be a film-like member that is adhered to the insulating substrate 110.

The tab 150A is joined to the first conductive layer 120 and the second conductive layer 130 by, for example, ultrasonic welding. The tab 150A extends from the insulating substrate 110 toward the upper portion of the battery 1 (see FIG. 1). The extending direction of the tab 150A is along the orthogonal direction DO.

The tab 150A is joined to the first coupling member mentioned above by, for example, ultrasonic welding. The tab 150A includes a first foil portion 151 and a second foil portion 152. The first foil portion 151 is located on the opposite side of the insulating substrate 110 side when viewed from the first conductive layer 120. The first foil portion 151 is joined to the first conductive layer 120. The first foil portion 151 and the first conductive layer 120 are joined to each other by, for example, ultrasonic welding. The second foil portion 152 is located on the opposite side of the insulating substrate 110 side when viewed from the second conductive layer 130. The second foil portion 152 is joined to the second conductive layer 130. The second foil portion 152 and the second conductive layer 130 are joined to each other by, for example, ultrasonic welding. The second foil portion 152 is joined to the first foil portion 151 on the opposite side of the body portion 118 side when viewed from the protruding piece portion 119. The first foil portion 151 and the second foil portion 152 are joined to each other by, for example, ultrasonic welding.

In the present embodiment, the length of the first foil portion 151 in the orthogonal direction DO orthogonal to the thickness direction DT is longer than the length of the second foil portion 152 in the orthogonal direction DO. The first foil portion 151 is joined to the first coupling member mentioned above, and the second foil portion 152 is not joined to the first coupling member mentioned above. However, the form of the tab 150A is not limited thereto. The first foil portion 151 or the second foil portion 152 may be joined to the first coupling member. The length of the second foil portion 152 in the orthogonal direction DO may be longer than the length of the first foil portion 151 in the orthogonal direction DO.

The first active material layer 200A is stacked on the first conductive layer 120. The first active material layer 200A is a positive electrode active material layer. In the present embodiment, the first active material layer 200A is also stacked on the second conductive layer 130. The first active material layer 200A includes an inner active material layer 210A and an outer active material layer 220A. The inner active material layer 210A is stacked on the first conductive layer 120. The outer active material layer 220A is stacked on the second conductive layer 130.

The upper edge of the first active material layer 200A is spaced apart from the tab 150A. More specifically, the upper edge of the inner active material layer 210A is spaced apart from the first foil portion 151. The upper edge of the outer active material layer 220A is spaced apart from the second foil portion 152.

The protective portion 300 has electrical insulation properties and is made of, for example, ceramic. The protective portion 300 covers the upper part of first active material layer 200A. The protective portion 300 further covers the first current collector 100A between the tab 150A and the first active material layer 200A.

The protective portion 300 includes an inner protective portion 310 and an outer protective portion 320. The inner protective portion 310 covers the upper part of the inner active material layer 210A. The inner protective portion 310 covers the first conductive layer 120 between the first foil portion 151 and the inner active material layer 210A. The outer protective portion 320 covers the upper part of the outer active material layer 220A. The outer protective portion 320 covers the second conductive layer 130 between the second foil portion 152 and the outer active material layer 220A.

In this manner, the first current collector 100A (electrode member) according to the present embodiment includes the insulating substrate 110 and a conductive layer (e.g., the first conductive layer 120) provided on a surface of the insulating substrate 110. The fillers 180 that reduce the difference between the linear expansion coefficient of the insulating substrate 110 and the linear expansion coefficient of the conductive layer are dispersed inside the insulating substrate 110. The difference between the linear expansion coefficient of the insulating substrate 110 in which the fillers 180 are dispersed and the linear expansion coefficient of the conductive layer is within ±20% of the linear expansion coefficient of the conductive layer. This reduces the difference between the linear expansion coefficient of the insulating substrate 110 and the linear expansion coefficient of the conductive layer. Therefore, with the first current collector 100A (electrode member) according to the present embodiment, peeling of the conductive layer in the electrode member can be suppressed.

In the present embodiment, the fillers 180 are glass fibers. Thus, with the first current collector 100A (electrode member) according to the present embodiment, the linear expansion coefficient of the insulating substrate 110 can be more suitably controlled.

In the present embodiment, in the protruding piece portion 119, the longitudinal direction DQ of the fillers 180 is parallel to the protruding direction DP of the protruding piece portion 119. Thus, with the first current collector 100A (electrode member) according to the present embodiment, it is possible to suppress the protruding piece portion 119 tearing in a direction (e.g., the winding direction DR of the insulating substrate 110) intersecting the protruding direction DP.

### Modifications

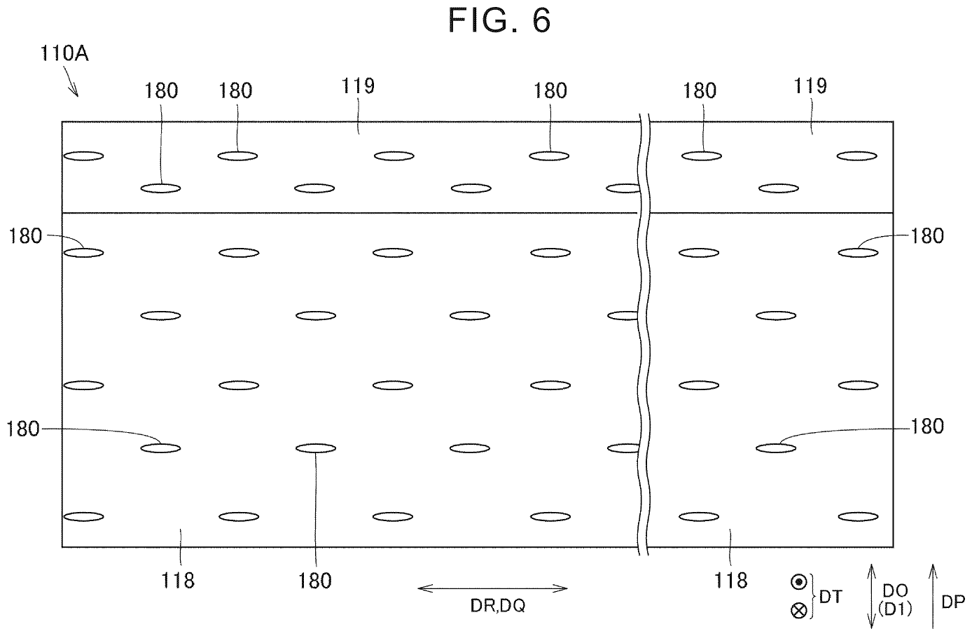

An insulating substrate according to a modification will be described with reference to FIG. 6. FIG. 6 is a development view of an insulating substrate according to a modification. FIG. 6 illustrates an insulating substrate 110A according to the modification in a state before being wound. The insulating substrate 110A is different from the insulating substrate 110 (see FIG. 5) mentioned above in the orientation of the fillers 180.

More specifically, in the protruding piece portion 119 of the insulating substrate 110A, the longitudinal direction DQ of the fillers 180 intersects the protruding direction DP of the protruding piece portion 119 of the insulating substrate 110A. Also in the body portion 118 of the insulating substrate 110A, the longitudinal direction DQ of the fillers 180 intersects the protruding direction DP of the protruding piece portion 119. More specifically, in a wound body obtained by winding the insulating substrate 110A, the longitudinal direction DQ of the fillers 180 provided in the body portion 118 of the insulating substrate 110A is along the winding direction DR of the insulating substrate 110A. In other respects, the insulating substrate 110A is the same as the insulating substrate 110.

Since the longitudinal direction DQ of the fillers 180 in the protruding piece portion 119 intersects the protruding direction DP of the protruding piece portion 119, it is possible to suppress the protruding piece portion 119 tearing in the protruding direction DP. Furthermore, when the first current collector 100A (see FIG. 4) includes the insulating substrate 110A instead of the insulating substrate 110, the longitudinal direction DQ of the fillers 180 provided in the body portion 118 is along the winding direction DR of the insulating substrate 110A, and thus the insulating substrate 110A is less likely to shrink with respect to each of the first conductive layer 120 and the second conductive layer 130 (see FIG. 4).

In the body portion 118 of the insulating substrate 110A, the longitudinal direction DQ of the fillers 180 may be parallel to the protruding direction DP of the protruding piece portion 119.

The embodiment disclosed herein should be considered to be illustrative in all respects and not restrictive. The scope of the present disclosure is set forth in the claims and not the above description, and is intended to encompass all modifications within the meaning and scope equivalent to those of the claims.

What is claimed is:

1. An electrode member comprising:
an insulating substrate; and
a conductive layer provided on a surface of the insulating substrate, wherein:
a plurality of fillers that reduces a difference between a linear expansion coefficient of the insulating substrate and a linear expansion coefficient of the conductive layer is dispersed inside the insulating substrate; and
the difference between the linear expansion coefficient of the insulating substrate in which the fillers are dispersed and the linear expansion coefficient of the conductive layer is within ±20% of the linear expansion coefficient of the conductive layer.

2. The electrode member according to claim 1, wherein the fillers are glass fibers.

3. The electrode member according to claim 1, wherein:
the insulating substrate includes a body portion on which an active material layer is stacked, and a protruding piece portion that is connected to the body portion and protrudes outward from the body portion;
the fillers have an elongated shape; and
in the protruding piece portion, a longitudinal direction of the fillers is parallel to a protruding direction of the protruding piece portion.

4. The electrode member according to claim 1, wherein:
the insulating substrate includes a body portion on which an active material layer is stacked, and a protruding piece portion that is connected to the body portion and protrudes outward from the body portion;
the fillers have an elongated shape; and
in the protruding piece portion, a longitudinal direction of the fillers intersects a protruding direction of the protruding piece portion.

5. The electrode member according to claim 1, wherein:
the insulating substrate includes a body portion on which an active material layer is stacked, and a protruding piece portion that is connected to the body portion and protrudes outward from the body portion;
the fillers have an elongated shape; and
in a wound body obtained by winding the insulating substrate, a longitudinal direction of the fillers provided in the body portion is along a winding direction of the insulating substrate.
